(19) United States
(12) Patent Application Publication
(10) Pub. No.: US 2026/0220564 A1
(43) Pub. Date: Jul. 30, 2026

(54) INFORMATION PROCESSING DEVICE, INFORMATION PROCESSING SYSTEM, INFORMATION PROCESSING METHOD, AND NON-TRANSITORY COMPUTER-READABLE MEDIUM HAVING PROGRAM STORED THEREIN

(71) Applicant: NEC Corporation, Tokyo (JP)

(72) Inventors: Yaeko YONEZAWA, Tokyo (JP); Soma SHIRAISHI, Tokyo (JP); Syunsuke YAMAMOTO, Tokyo (JP); Yuji TAHARA, Tokyo (JP); Naohiro HAYASHI, Tokyo (JP); Azusa nagasawa, Tokyo (JP); Ryosuke SAKAI, Tokyo (JP); Tomokazu KANEKO, Tokyo (JP); Takami SATO, Tokyo (JP)

(73) Assignee: NEC Corporation, Tokyo (JP)

(21) Appl. No.: 19/145,961

(22) PCT Filed: Mar. 29, 2023
(86) PCT No.: PCT/JP2023/012859

§ 371 Date: Jul. 7, 2025

(51) Int. Cl. G06Q 10/0631

(52) U.S. Cl. CPC G06Q 10/063112; G06Q 10/063116

(57) ABSTRACT

An information processing device according to an embodiment includes an identifying unit, a notification target determination unit, a notification method determination unit, and a notification output unit. The identifying unit identifies a shelf for which handling relating to the display of a commodity is required. The notification target determination unit determines, on the basis of the identified shelf or the commodity displayed on the shelf and information relating to a worker, a target person to whom the handling request is to be notified. The notification method determination unit determines, on the basis of at least one of the identified shelf or the commodity displayed on the shelf, and the determined target person, a notification method by which the target person can be made aware of the shelf or the commodity. The notification output unit outputs, to the determined target person, notification information by means of the determined notification method.

### TECHNICAL FIELD

The present disclosure relates to an information processing device, an information processing system, an information processing method, and a non-transitory computer-readable medium storing a program.

### BACKGROUND ART

Various techniques for managing tasks to be performed by a clerk in a store have been proposed. For example, PTL 1 discloses an information processing system configured to enable a clerk to appropriately grasp a task to be preferentially performed from among tasks that occur sequentially. This information processing system uses a camera or a sensor to detect a predetermined event related to a task to be performed by a clerk and generate predetermined alert information, identifies a task to be instructed to be performed by the clerk based on the alert information, and determines a priority for each task. Since the tasks that need to be performed by the clerk are output in a prioritized manner, the clerk can appropriately grasp the task to be preferentially performed.

In PTL 1, processing of assigning a task to a clerk is performed based on mapping information for task assignment, a current task execution status of the clerk, log information indicating a result of execution of a task by the clerk, a shift schedule of the clerk, and the like. Only tasks related to one worker are displayed on the tablet terminal assigned to each clerk.

### CITATION LIST

### Patent Literature

PTL 1: JP 2016-4384 A

### SUMMARY OF INVENTION

### Technical Problem

In a store such as a supermarket, an operation of prescribing in advance how to display commodities on a display shelf (display position, number of displays, number of face, etc.) and displaying commodities according to the prescriptions may be performed. However, even if such an operation is performed, there are cases where commodities are not actually displayed in accordance with the prescriptions.

For example, in a case where a commodity is out of stock, a case where a face (display surface) of the commodity is not arranged facing the front, or the like, it is necessary for a worker to take various handlings such as stocking the commodity, advancing the commodity in front, and arranging the commodity in order on the display shelf. In a case where a worker visually checks a display status of the commodity and checks which commodity or which display shelf needs to be handled, there is a problem that a work load is large and work efficiency is poor.

In view of the above-described problems, an object of the present disclosure is to provide an information processing device, an information processing system, an information processing method, and a program capable of improving work efficiency of a worker.

### Solution to Problem

An information processing device according to an aspect of the present disclosure includes an identifying means, a notification target determination means, a notification method determination means, and a notification output means. The identifying means identifies a shelf for which handling relating to the display of a commodity is required. The notification target determination means determines, based on the identified shelf or the commodity displayed on the shelf and information relating to a worker, a target person to whom the handling request is to be notified. The notification method determination means determines, based on at least one of the identified shelf or the commodity displayed on the shelf, and the determined target person, a notification method by which the target person can be made aware of the shelf or the commodity. The notification output means outputs, to the determined target person, notification information by means of the determined notification method.

An information processing system according to an aspect of the present disclosure includes an identifying means, a notification target determination means, a notification method determination means, and a notification output means. The identifying means identifies a shelf for which handling relating to the display of a commodity is required. The notification target determination means determines, based on the identified shelf or the commodity displayed on the shelf and information relating to a worker, a target person to whom the handling request is to be notified. The notification method determination means determines, based on at least one of the identified shelf or the commodity displayed on the shelf, and the determined target person, a notification method by which the target person can be made aware of the shelf or the commodity. The notification output means outputs, to the determined target person, notification information by means of the determined notification method.

In an information processing method according to an aspect of the present disclosure, a computer executes the following processing. The processing includes: identifying a shelf that needs to be handled regarding display of a commodity; determining a target person to be notified of a handling request based on the identified shelf or the commodity displayed on the shelf and information relating to a worker; determining a notification method by which the target person can recognize the shelf or the commodity based on at least one of the identified shelf or the commodity displayed on the shelf, and the determined target person; and outputting notification information according to the determined notification method to the determined target person.

A non-transitory computer-readable medium according to an aspect of the present disclosure stores a program for causing a computer to execute the following processing. The processing includes: identifying a shelf that needs to be handled regarding display of a commodity; determining a target person to be notified of a handling request based on the identified shelf or the commodity displayed on the shelf and information relating to a worker; determining a notification method by which the target person can recognize the shelf or the commodity based on at least one of the identified shelf or the commodity displayed on the shelf, and the determined target person; and outputting notification information according to the determined notification method to the determined target person.

### Advantageous Effects of Invention

According to the present disclosure, the work efficiency of the worker can be improved.

### BRIEF DESCRIPTION OF DRAWINGS

FIG. 1 is a block diagram illustrating a configuration of an information processing device according to a first example embodiment.

FIG. 2 is a flowchart for explaining a flow of an information processing method according to the first example embodiment.

FIG. 3 is a block diagram illustrating a configuration of an information processing system according to the first example embodiment.

FIG. 4 is a block diagram illustrating an overall configuration of an information processing system according to a second example embodiment.

FIG. 5 is a diagram illustrating an example of a store to which the information processing system according to the second example embodiment is applied.

FIG. 6 is a block diagram illustrating a functional configuration of a worker terminal of FIG. 4.

FIG. 7 is a block diagram illustrating a functional configuration of a server of FIG. 4.

FIG. 8 is a diagram for explaining an example of identifying a shelf storing a commodity that needs to be handled based on a captured image obtained by photographing the display shelf.

FIG. 9 is a diagram illustrating an example of a table in which a worker ID and the commodity are associated with each other.

FIG. 10 is a diagram illustrating a flow of an information processing method by the information processing system according to the second example embodiment.

FIG. 11 is a diagram illustrating a flow of an information processing method by the information processing system according to the second example embodiment.

### EXAMPLE EMBODIMENT

Hereinafter, example embodiments of the present disclosure will be described in detail with reference to the drawings. In the drawings, the same or relevant elements are denoted by the same reference numerals, and redundant description is omitted as necessary for clarity of description.

An example embodiment relates to a technique for improving efficiency of work performed by a worker if displaying a commodity on a display shelf in a selling area of a store such as a convenience store or a supermarket. Normally, a plurality of display shelves are installed in a store. In each display shelf, a plurality of shelf boards for arranging commodities are arranged in the vertical direction. The display shelf is not limited to one having a plurality of shelf boards. The display shelf may be any place where commodities are displayed. For example, in a case where commodities are stacked on a table, the table can be treated as the display shelf.

As an important factor that stimulates customers' desire to purchase and affects sales of commodities, there is allocation (shelf layout) of the commodity to a display shelf in a case where the commodity is displayed on the display shelf. The shelf layout defines in advance how to display commodities on the display shelf (display position, number of displays, number of face, etc.). The number of faces indicates how many rows of commodities are arranged in the display shelf. The shelf layout may be changed according to sales and seasons. Commodities are displayed on each shelf board according to a predetermined shelf layout.

In a selling area, if the displayed commodities are insufficient (out of stock) or the display of commodities is disordered, there is a possibility that the customers' desire to purchase is reduced, sales opportunities of commodities are lost, and sales are reduced. Therefore, the display shelf is monitored to check whether there is an abnormality in the display state of the commodity, and in a case where there is an abnormality, it is necessary to quickly perform a stocking work and a tidying work of the commodity in order to eliminate the abnormality of the commodity.

At the time of displaying the commodity, a first-in first-out work of taking out the commodity purchased first, and an advancing work are performed from the viewpoint of ensuring a state in which a customer can easily hold the commodity. The advancing work is a work of moving the commodity on the back side to the front side in a case where the commodity on the front side of the shelf board is sold. In this manner, the display shelf is managed so that commodities are constantly in a first-in first-out manner to prevent old commodities from remaining and to be always in a tidy state.

If notifying the worker about the abnormality of the display shelf based on the monitoring of the display shelf, if the notification is issued to all the workers, work for confirming the notification occurs, and the work efficiency of unrelated workers is reduced. The present inventors have devised the following technique in order to allow a worker who performs the work to reliably recognize the above work related to a shelf on which commodities that needs to be handled are displayed and to improve work efficiency.

### First Example Embodiment

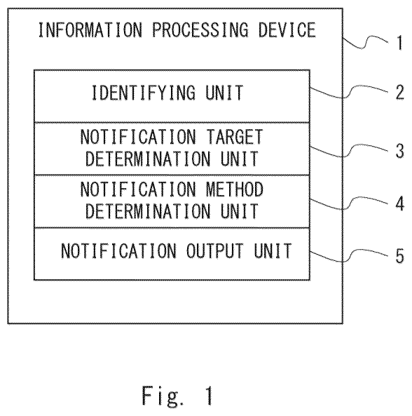

FIG. 1 is a block diagram illustrating a configuration of an information processing device 1 according to a first example embodiment. As illustrated in FIG. 1, the information processing device 1 includes an identifying unit 2, a notification target determination unit 3, a notification method determination unit 4, and a notification output unit 5. The information processing device 1 can perform various communications with an external device via a network. Specifically, the information processing device 1 can be connected to a worker terminal or the like possessed by a worker via a communication line such as the Internet. However, the communication line is not limited to the Internet, and may be a combination of the Internet and another communication line or a communication line other than the Internet. As the communication method, for example, wireless communication or wired communication such as 4G (Generation), 5G, local 5G, Wi-Fi (registered trademark), or long term evolution (LTE) can be used. The communication method is not limited to these examples.

The identifying unit 2 identifies a display shelf (hereinafter, referred to as a target display shelf) on which commodities that need to be handled are displayed. For example, the identifying unit 2 can identify the target display shelf based on a shelf image in which a display shelf on which commodities are displayed is photographed. Specifically, the identifying unit 2 can identify the target display shelf by comparing actual display information obtained by image analysis of the shelf image with reference display information indicating a standard of display of commodities in the display shelf. The reference display information indicates information related to the position of each commodity in the display shelf, the number of displays, and the like determined by the above-described shelf layout.

The identifying unit 2 may identify the target display shelf not only based on the shelf image but also by adopting another arbitrary method. For example, the identifying unit 2 can identify the target display shelf based on a detection result of a pressure sensor or a weight sensor installed in the display shelf. The identifying unit 2 can identify a physically moved commodity and identify a target display shelf by receiving a transmission signal from a radio tag attached to the commodity.

The notification target determination unit 3 determines, based on the identified shelf or the commodity displayed on the shelf and information relating to a worker, a target person to whom the handling request is to be notified. The information relating to the worker can be, for example, worker identification information such as an ID that uniquely identifies the worker associated with the commodity or the shelf. For example, a table holding a correspondence relationship between identification information of a worker and the shelf or the commodity which the worker is in charge of may be stored in a storage device (not illustrated). The information relating to the worker may be position information, behavior information, or a behavior history of the worker. A method of determining the target person to be notified of the handling request will be described in detail later.

The notification method determination unit 4 determines, based on at least one of the identified shelf or the commodity displayed on the shelf, and the determined target person, a notification method by which the target person can be made aware of the shelf or the commodity. For example, the notification method determination unit 4 can determine a different notification method according to the identified shelf. The notification method may include voice, sound, vibration, and display. For example, any one of a voice pattern, a sound pattern, and a vibration pattern different for each display shelf, or a combination thereof can be adopted. The notification method may include pop-up display in which the notification content is displayed in a large size at the center of the screen of the worker terminal or banner display in which the notification content is displayed in a small size at the upper end of the screen. As a result, the worker who is the target person can recognize which shelf requires handling only by receiving the notification.

The notification method determination unit 4 may determine different types of notification methods according to the determined target person. For example, the notification method determination unit 4 can determine different types of notification methods according to the number of target persons. The notification method determination unit 4 can perform different display on the worker terminal possessed by the target person depending on whether the number of target persons is one or more. In other words, the notification method determination unit 4 can change the notification method depending on the magnitude of the handling request to the target person.

For example, in a case where there is one target person, the target person necessarily has to perform a predetermined work on the commodity on the identified shelf, and the responsibility for the work becomes heavy. In this case, the worker terminal of the target person can display in a large font size or in a color that attracts attention such as red or yellow. The brightness of the screen of the worker terminal in the case of notifying one person may be brighter than that in the case of notifying a plurality of persons.

The notification output unit 5 outputs, to the worker terminal, notification information with respect to the determined target person by means of the determined notification method. The worker terminal that has received the notification information can notify the worker carrying the worker terminal of the handling request by means of the determined notification method.

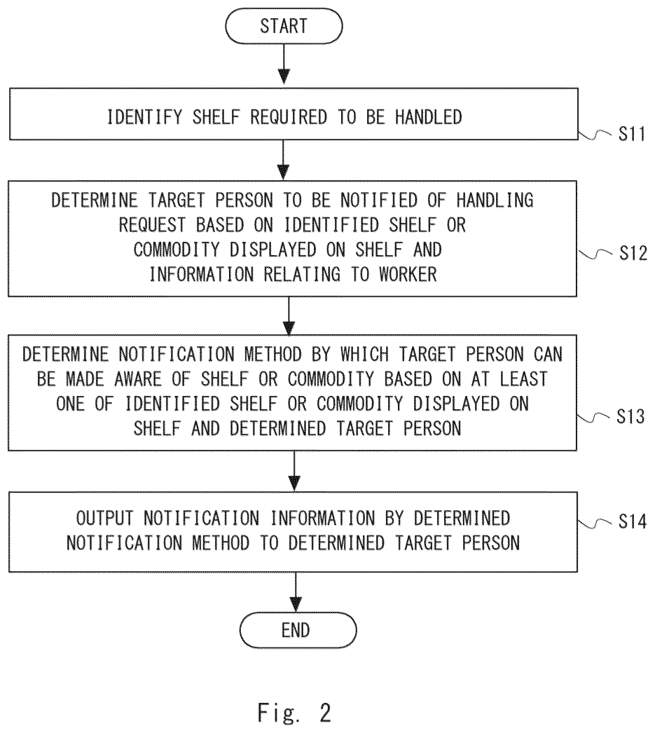

Next, processing performed by the information processing device 1 will be described with reference to FIG. 2. FIG. 2 is a flowchart illustrating an information processing method performed by the information processing device 1 according to the first example embodiment. First, the information processing device 1 identifies the shelf on which the commodity that need to be handled are displayed (S11). Next, the information processing device 1 determines, based on the identified shelf or the commodity displayed on the shelf and information relating to a worker, a target person to whom the handling request is to be notified (S12).

Next, a notification method by which the target person can be made aware of the shelf or the commodity is determined based on at least one of the identified shelf or the commodity displayed on the shelf, and the determined target person (S13). Then, notification information by means of the determined notification method is output to the determined target person (S14). As described above, according to the information processing device 1 according to the first example embodiment, it is possible to cause the worker who performs the work to reliably recognize the work related to the shelf on which the commodity that needs to be handled is displayed, and to improve the work efficiency.

The information processing device 1 includes a processor, a memory, and a storage device as configurations, not illustrated. The storage device stores a program for causing a computer to execute each process of the management method according to the first example embodiment. The processor also reads a program from the storage device to the memory and executes the program. As a result, the processor implements the functions of the identifying unit 2, the notification target determination unit 3, the notification method determination unit 4, and the notification output unit 5.

Each constituent of the information processing device 1 may be achieved by dedicated hardware. Some or all of the components of each device may be implemented by a general-purpose or dedicated circuitry, a processor, or a combination thereof. These may be configured by a single chip or may be configured by a plurality of chips connected via a bus. Some or all of the components of each device may be achieved by a combination of the above-described circuit or the like and a program. As the processor, a central processing unit (CPU), a graphics processing unit (GPU), a field-programmable gate array (FPGA), a quantum processor (quantum computer control chip), or the like may be used.

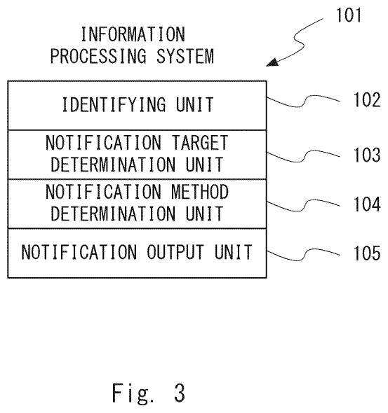

In a case where some or all of the components of the information processing device 1 are achieved by a plurality of devices, circuits, and the like, the plurality of devices, circuits, and the like may be arranged in a centralized manner or in a distributed manner. FIG. 3 is a block diagram illustrating a configuration of an information processing system 101 according to the first example embodiment. As illustrated in FIG. 3, the information processing system 101 includes an identifying unit 102, a notification target determination unit 103, a notification method determination unit 104, and a notification output unit 105. As described above, the detailed operation of each configuration of the information processing system 101 is relevant to the operation of each configuration of the information processing device 1. The devices, circuits, and the like for achieving each component of FIG. 3 may be implemented in the form of a client server system, a cloud computing system, or the like in which they are connected to each other through a communication network. The functions of the information processing device 1 may be provided in software as a service (Saas) format.

### Second Example Embodiment

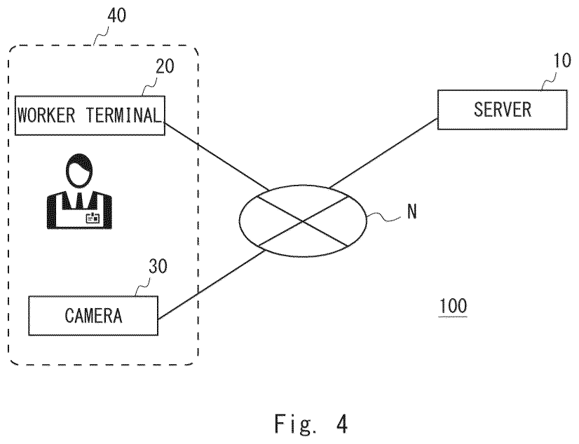

The second example embodiment is a specific example of the above-described first example embodiment. FIG. 4 is a block diagram illustrating an overall configuration of an information processing system 100 according to a second example embodiment. The information processing system 100 includes a server 10 and a worker terminal 20. The server 10 and the worker terminal 20 are connected via a network N. Here, the network N is a wired or wireless communication line, for example, the Internet.

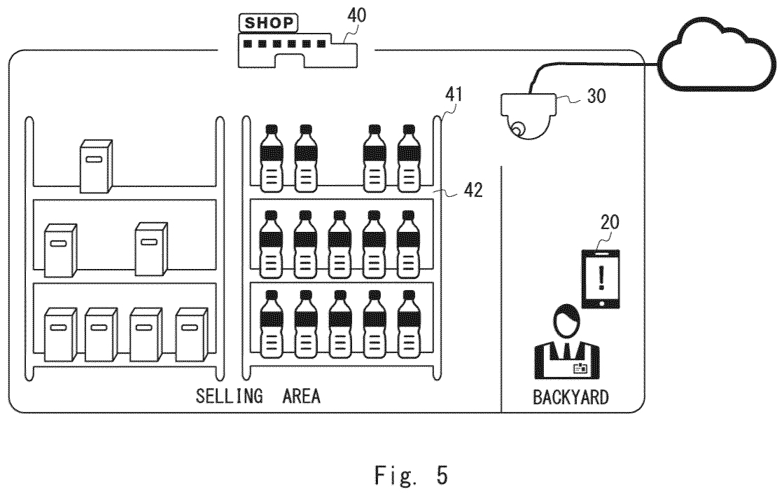

FIG. 5 is a diagram illustrating an example of a store to which the information processing system 100 according to the second example embodiment is applied. Here, an example of identifying the shelf on which commodities that need to be handled are displayed based on the shelf image captured by a camera 30 installed in the store 40 will be described. As a technology for identifying the display shelf based on the shelf image, for example, a technology disclosed in WO 2019/065212 A can be adopted.

As illustrated in FIG. 5, the store 40 is roughly divided into a selling area and a backyard. A plurality of display shelves 41 are installed in the selling area. In each of the plurality of display shelves 41, a plurality of shelf boards 42 for arranging commodities are arranged in the vertical direction. The camera 30 is installed so as to be able to photograph all the commodities displayed on the display shelf 41. The camera 30 is an imaging device capable of performing imaging and generating a captured image.

The plurality of cameras 30 may be arranged at different positions in the store 40 so as to photograph the plurality of display shelves 41. The photographing direction of one camera may be changed every predetermined time, and each of the plurality of display shelves may be photographed. The camera 30 may photograph one display shelf 41 divided into a plurality of ranges. That is, the entire one display shelf 41 may be photographed by a plurality of shelf images. The camera 30 may be a monitoring camera or a camera provided in a smartphone, a tablet terminal, or the like.

The worker manages the display shelf in a state of carrying the worker terminal 20. For example, the worker displays commodities on the display shelf 41 according to a predetermined shelf layout. As an example, in a case where the commodity displayed on the display shelf 41 is in shortage or out of stock, the worker carries out the stocking work of bringing a new commodity from the backyard where the commodity is in stock and replenishing the commodity to the display shelf 41. The worker performs the tidying work of aligning the direction of the commodity such that the face surface of the commodity faces the front, or returning the commodity left at a position different from the shelf layout to a correct position. Further, the worker performs the first-in first-out work or the advancing work so that the old commodity comes to the front side of the shelf board 42. The worker recognizes, via the worker terminal 20, the shelf on which commodities that require such handling are displayed.

### <Worker Terminal 20>

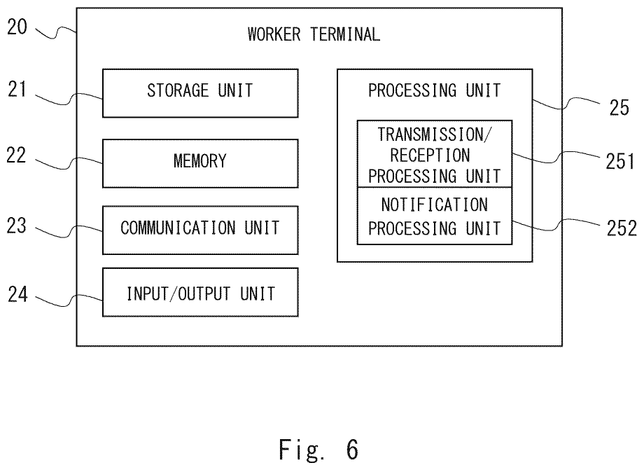

A worker terminal 20 is an information terminal used by a worker to transmit and receive data to and from a server 10 via a network N by wireless communication. The worker terminal 20 is, for example, a smartphone, a tablet, or the like, and outputs information relating to the shelf on which commodities that need to be handled by the worker are displayed. FIG. 6 is a block diagram illustrating a configuration of the worker terminal 20 of FIG. 4.

The worker terminal 20 includes a storage unit 21, a memory 22, a communication unit 23, an input/output unit 24, and a processing unit 25. As described later, the worker terminal 20 may include a positioning means such as a GPS antenna and a beacon, an acceleration sensor, a gyro sensor, and the like. The storage unit 21 is an example of a storage device including a non-volatile memory such as a flash memory or a solid state drive (SSD). The storage unit 21 stores a program in which processing including a process of notifying the determined target person by the determined notification method and the like is implemented based on the notification information output from the server 10.

The memory 22 is a volatile storage device such as a random access memory (RAM) and is a storage area for temporarily holding information during operations of the processing unit 25. The communication unit 23 is a communication interface with the network N. The communication unit 23 may establish connection for near field communication to perform communication. Here, various standards such as Bluetooth (registered trademark), Bluetooth Low Energy (BLE), and Ultra Wide Band (UWB) can be applied to the near field communication.

The input/output unit 24 can include a display device such as a screen and an input device such as a keyboard. The input/output unit 24 may be a touch panel in which a display device and an input device are integrated. For example, the display device can display information relating to the display shelf 41 that needs to be handled in the store 40 based on the notification information from the server 10. By visually recognizing the screen displayed on the display device, the worker can confirm the work that he/she should handle among the works related to the target display shelf.

A method of presenting work information related to the target display shelf is not limited to a visual method such as display on a display device, and may be presented by, for example, vibration, voice, warning sound, or the like. Therefore, the input/output unit 24 can include a speaker, a vibrator, and the like.

The worker can input information relating to work performed by the worker among the work regarding the target display shelf using the input device as necessary. For example, if completing the work related to the target display shelf, the worker can input information indicating that the work has been handled. For example, a check box for inputting whether the work has been handled may be displayed on the screen of the touch panel.

The processing unit 25 is a processor that controls hardware included in the worker terminal 20. The processing unit 25 reads the program from the storage unit 21 into the memory 22 and executes the program. As a result, the processing unit 25 implements the functions of a transmission/reception processing unit 251 and a notification processing unit 252. The transmission/reception processing unit 251 receives, from the server 10, notification information for notifying the determined target person of the handling request by means of the determined notification method.

The notification processing unit 252 notifies the worker of the information relating to the target display shelf by the determined notification method based on the notification information. For example, the notification processing unit 252 can cause the input/output unit 24 to display a screen generated by execution of the program. For example, the notification processing unit 252 can display information relating to a commodity that needs to be handled, a position of a display shelf on which the commodity is displayed, and the number of workers who have simultaneously received this notification. As will be described in detail later, the transmission/reception processing unit 251 can transmit the position information of the worker terminal 20 and the behavior information of the worker to the server 10 as necessary.

### <Server 10>

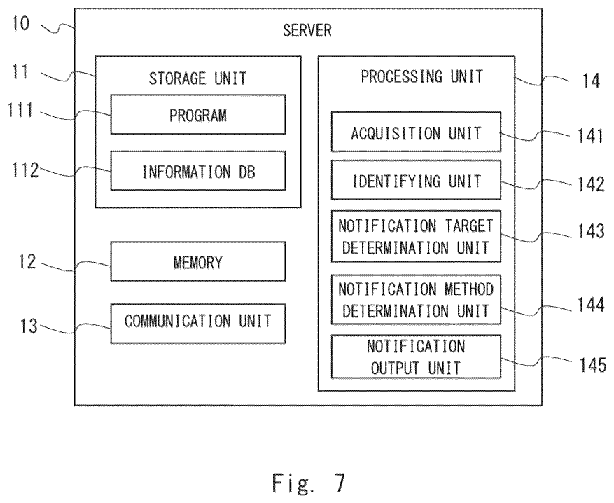

The server 10 is an information processing device that achieves an identifying function of the display shelf, a notification target determination function, and a notification method determination function. The server 10 may include a plurality of servers, and each functional block may be achieved by a plurality of computers. FIG. 7 is a block diagram illustrating the configuration of the server 10 of FIG. 4. As illustrated in FIG. 7, the server 10 includes a storage unit 11, a memory 12, a communication unit 13, and a processing unit 14. The storage unit 11 is an example of a storage device such as a hard disk or a flash memory.

The storage unit 11 stores a program 111 and an information DB 112. The program 111 is a computer program in which some of the identifying function of the display shelf, the notification target determination function, the notification method determination function, and the like are implemented. The information DB 112 is a database that manages various types of information relating to the worker. The information DB 112 stores worker information including at least one of a worker ID, position information of the worker, behavior information, and a behavior history. The worker information will be described in detail later. The information DB 112 stores reference display information for comparison with actual display information acquired from shelf images. The reference display information can be, for example, identification information such as a commodity name and a Japanese Article Number (JAN) code of each commodity displayed in the display shelf 41, position information of each commodity in the display shelf 41, the number of faces, the number of displays, and the like.

The memory 12 is a volatile storage device such as a RAM, and is a storage region for temporarily holding information during operations of the processing unit 14. The communication unit 13 is a communication interface with the network N. The processing unit 14 is a processor that controls each component of the server 10. The processing unit 14 reads the program 111 from the storage unit 11 into the memory 12 to execute the program 111. As a result, the processing unit 14 implements the functions of an acquisition unit 141, an identifying unit 142, the notification target determination unit 143, the notification method determination unit 144, and the notification output unit 145.

The acquisition unit 141 acquires the shelf image obtained by photographing the shelf on which commodities are displayed from the camera 30. For example, the acquisition unit 141 may acquire the shelf image captured by a camera provided in the worker terminal 20. The acquisition unit 141 can acquire position information and behavior information of the worker from the worker terminal 20 or the like as necessary.

The identifying unit 142 identifies a target display on which a commodity that needs to be handled is displayed. Here, the identifying unit 142 generates the actual display information by performing image analysis on the shelf image, and compares the actual display information with the reference display information based on the shelf layout to identify the target display shelf.

For example, the identifying unit 142 extracts an image region representing each commodity from the shelf image and performs known image analysis to generate actual display information. Then, the identifying unit 142 compares the actual display information with the reference display information, and determines whether the display shelf 41 included in the shelf image satisfies the reference, that is, whether commodities are arranged according to a predetermined shelf layout.

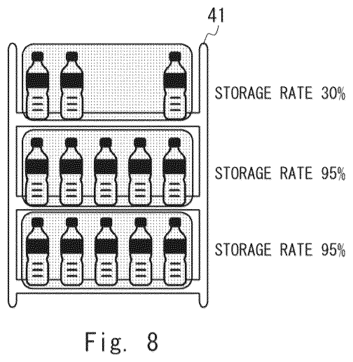

FIG. 8 is a diagram for explaining an example of identifying the shelf storing a commodity that needs to be handled based on a captured image obtained by photographing the display shelf. Here, an example of identifying the shelf that needs to be handled according to the number of commodities displayed in the display shelf 41 will be described. Here, a ratio of the number of commodities displayed in the actual display information to the number of commodities displayed in the reference display information is defined as a storage rate of the display shelf. FIG. 8 illustrates the shelf image of the shelf on which PET bottles are displayed among the display shelves 41 illustrated in FIG. 5. The storage rate in each shelf board 42 as a result of comparing the actual display information generated from the shelf image with the reference display information is displayed to be superimposed on the shelf image in FIG. 8.

As illustrated in FIG. 8, the lower and middle stages of the display shelf 41 have a storage rate of 95%, and the upper stage has a storage rate of 30%. As described above, in a case where the number of commodities displayed is less than the predetermined standard, it is necessary to take commodities from the storage place and replenish commodities. Therefore, the display shelf 41 is identified as a target display shelf on which a commodity that needs to be handled is arranged.

The notification target determination unit 143 determines, based on the identified shelf or the commodity displayed on the shelf and information relating to a worker, a target person to whom the handling request is to be notified. The target person may be one person or a plurality of persons. The information relating to the worker may be at least one of identification information of the worker associated with the commodity or the shelf, a behavior history of the worker, position information or behavior information of the worker. Therefore, the determination method of the target person may include the following examples.

(1) Example Using Table Associating Display Shelf or Commodity with Worker or Worker Terminal 20

A notification target determination unit 143 can determine a target person to be notified of the target request by using a table defining a correspondence relationship between either the display shelf or the commodity and the worker or the worker terminal 20. That is, in this example, a worker in charge of each display shelf or commodity is set in advance. For example, it is possible to use a table that holds information in which each commodity sold in a store 40 is associated with a worker ID or a terminal ID for identifying the worker terminal 20 possessed by each worker. The worker ID and the terminal ID are examples of worker identification information.

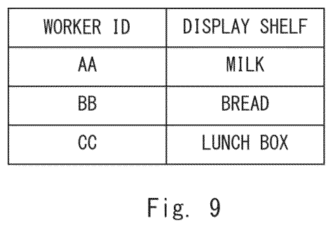

FIG. 9 is a diagram illustrating an example of a table. As illustrated in FIG. 9, a worker in charge of a commodity may be associated with a classification of the commodity such as milk or bread. This table is set in advance by an administrator or the like of the store 40 based on, for example, the ability of the worker or the like, and can be stored in the memory 12. For example, a commodity requiring a time-consuming handling can be assigned to a worker with high work efficiency. The table may be created by designating the display shelf that the worker is in charge of using an application program stored in the worker terminal 20.

### (2) Example Using Position Information of Worker

The notification target determination unit 143 may determine the target person based on the position information of the worker. For example, the worker terminal 20 carried by the worker includes positioning means such as a GPS antenna and a beacon, and the position information of the worker terminal 20 can be transmitted to the server 10. The notification target determination unit 143 can acquire the position information of the worker terminal 20 and determine the target person based on, for example, a distance to a display shelf on which a commodity that needs to be handled is displayed, a distance to the backyard that stores a stock of commodities, or the like.

### (3) Example Using Worker's Behavior Information

The notification target determination unit 143 may determine the target person based on the behavior information of the worker. For example, the worker terminal 20 carried by the worker includes an acceleration sensor, a gyro sensor, and the like, and can detect the movement of the worker terminal 20. The behavior information of the worker may be acquired by another device. For example, the worker may wear a motion sensor that detects his/her movement. Such a device can transmit various data acquired to the server 10 by near field communication or the like, for example.

Alternatively, the behavior information of the worker may be generated by analyzing video data captured by a camera provided in the store 40. The notification target determination unit 143 can determine, for example, a worker who is not performing other work or a worker whose workload is small in other work as the target person.

### (4) Example Using Worker's Behavior History

In a case where the worker who has performed the work can be identified from the video of the camera 30 or can be identified by the input from the worker terminal 20, the server 10 can generate the behavior history of each worker. The notification target determination unit 3 may determine the target person based on the behavior history of the worker. For example, the notification target determination unit 143 can determine K persons (K is an integer of 1 or more) as target persons in a descending order of the number of times of carrying out the stocking work to the target display shelf in the past. Alternatively, the notification target determination unit 143 may determine the K persons as the target persons in the ascending order of the number of times of carrying out the stocking work for not limited to the target display shelves.

The notification method determination unit 144 determines, based on at least one of the identified shelf or the commodity displayed on the shelf, and the determined target person, a notification method by which the target person can be made aware of the shelf or the commodity. For example, the notification method determination unit 144 can determine a different notification method according to the identified shelf. The notification method determination unit 144 can determine any one or a combination of the voice pattern, the sound pattern, and the vibration pattern set for each display shelf. As a result, the worker who is the target person can recognize which shelf requires handling only by receiving the notification.

The notification method determination unit 144 may determine different types of notification methods according to the determined target person. For example, the notification method determination unit 144 can determine different types of notification methods according to the number of target persons. The notification method determination unit 144 can perform different display on the worker terminal possessed by the target person depending on whether the number of target persons is one or more.

For example, in a case where the number of target persons is smaller than a predetermined number of persons, the responsibility for the work increases as compared with a case where the number of target persons is equal to or larger than the predetermined number of persons. In this case, the notification method determination unit 144 can determine the notification method such that, in a case where the number of target persons is smaller than the predetermined number of persons, the volume is made larger, the vibration interval of the vibration pattern is shortened, the display screen is made brighter, or the font size is made larger than in a case where the number of target persons is equal to or larger than the predetermined number of persons. As a result, the worker who is the target person can recognize the importance of the work upon receiving the notification.

The notification output unit 145 outputs, to the worker terminal 20 of the determined target person, notification information by means of the determined notification method. As described above, the worker terminal 20 can notify the worker of the information relating to the target display shelf by voice, sound, vibration, display, or the like based on the notification information. As described above, according to the information processing device 1 according to the second example embodiment, it is possible to cause the worker who performs the work to reliably recognize the work related to the shelf on which the commodity that needs to be handled is displayed, and to improve the work efficiency.

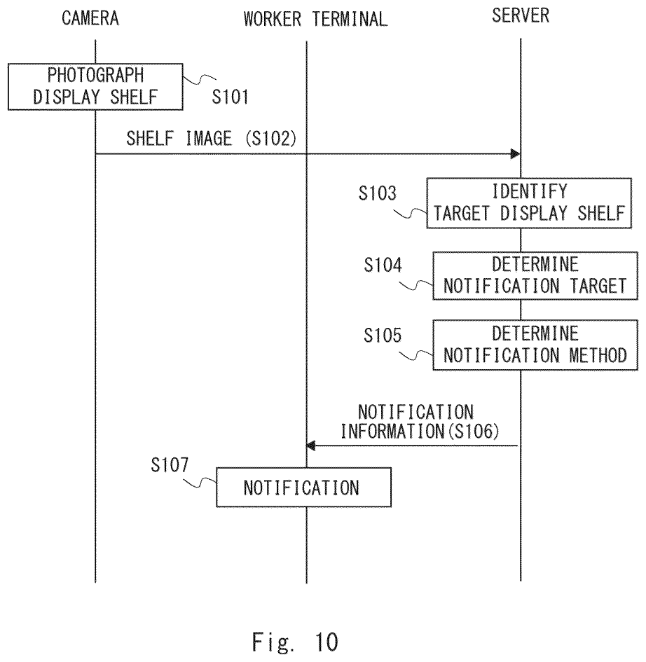

FIG. 10 is a diagram illustrating a flow of an information processing method by the information processing system according to the second example embodiment. First, the camera 30 photographs the display shelf 41 (S101) and transmits the shelf image to the server 10 (S102). Based on the shelf image, the server 10 identifies a display shelf (target display shelf) in which commodities that need to be handled are stored (S103).

Thereafter, a target to whom the handling request is to be notified is determined based on the identified shelf or the commodity displayed on the shelf and information relating to a worker (S104). Thereafter, the server 10 determines a notification method by which the target person can be made aware of the shelf or the commodity based on at least one of the identified shelf or the commodity displayed on the shelf, and the determined target person (S105). Then, notification information according to the determined notification method is output to the worker terminal 20 possessed by the determined target person (S106).

The worker terminal 20 notifies the worker of the information relating to the target display shelf by the notification method determined based on the notification information (S107). The worker can quickly perform work on the target display shelf according to the notification content from the worker terminal 20.

Even if the server 10 transmits the notification information to the worker terminal 20 and the worker terminal 20 performs the notification operation, there is a case where the worker to be notified cannot perform the work related to the target display shelf. In this case, the notification target determination unit 143 may further include processing of changing the target person according to the elapsed time from the time in a case where the notification information is output.

Whether the work related to the target display shelf has been completed can be determined based on, for example, information indicating whether the work has been handled, the information being input by the worker using the input device of the worker terminal 20. For example, whether the work related to the target display shelf has been completed may be determined based on whether the target display shelf has been arranged according to the shelf layout by using a captured image by a camera that photographs the display shelf or a detection result from a pressure sensor or the like provided on the shelf board 42.

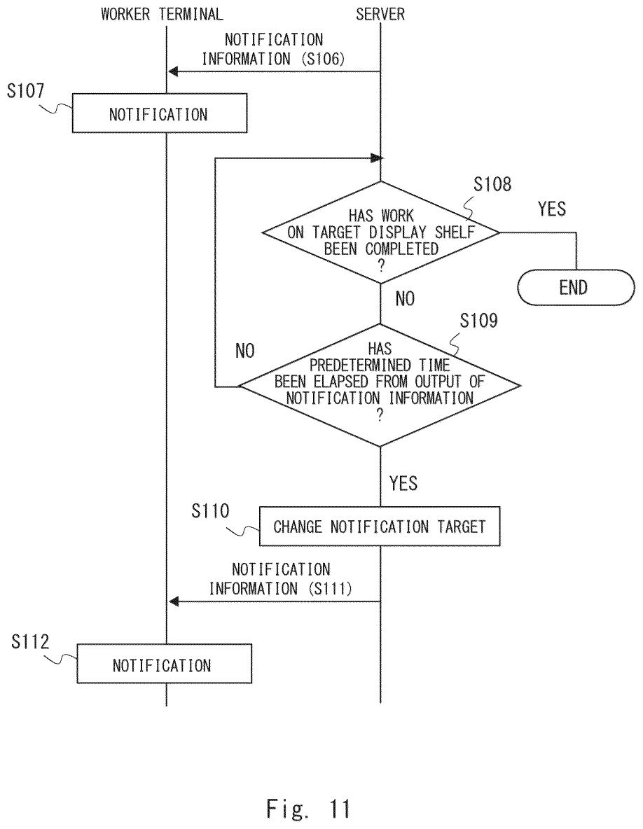

FIG. 11 is a flowchart illustrating processing subsequent to S107 in FIG. 10. As illustrated in FIG. 11, after the worker terminal 20 notifies the worker of information relating to the target display shelf (S107), the notification target determination unit 143 determines whether work on the target display shelf has been completed (S108). In a case where the work related to the target display shelf has been completed (S108YES), the process ends.

In a case where the work related to the target display shelf has not been completed (S108NO), the notification target determination unit 143 determines whether a predetermined time has elapsed since the notification information has been output (S109). In a case where the predetermined time has not elapsed in S109 (NO), the process returns to S108 to repeat the processing. In a case where the predetermined time has elapsed in S109 (YES), the notification target determination unit 143 changes the target person to be notified of the handling request (S110). In a case where the predetermined time has elapsed in S109 (YES), the notification method may be changed together with or instead of changing the target person who is notified of the handling request (S110).

For example, the notification target determination unit 143 can expand the target person. As an example, in a case where a worker in charge of each display shelf is set in advance, the notification target determination unit 143 adds the worker in charge of the display shelf adjacent to the target display shelf to the target person. This makes it possible to notify a larger number of workers than the number of target persons determined in the previous notification information of the information relating to the target display shelf.

Then, notification information according to the determined notification method is output to the worker terminal 20 possessed by the changed target person (S111). The worker terminal 20 notifies the worker of the information relating to the target display shelf by the notification method determined based on the notification information (S112).

As described above, according to the example embodiment, it is possible to cause the worker to reliably recognize the stocking work and the tidying work of the commodity. Since the notification information is output only to the worker terminal 20 to be notified, the worker does not stop the work with irrelevant notification. This makes it possible to improve work efficiency. It is possible to maintain the display state of commodities in each display shelf according to the shelf layout, and it is possible to improve the customers' desire to purchase and increase the opportunity to sell commodities.

In the example described above, the program includes a group of commands (or software codes) for causing a computer to execute one or more functions described in the example embodiments in a case where the program is read by the computer. The program may be stored in a non-transitory computer-readable medium or a tangible storage medium. As an example and not by way of limitation, the computer-readable medium or the tangible storage medium includes a RAM, a read-only memory (ROM), a flash memory, an SSD or any other memory technology, a CD-ROM, a digital versatile disc (DVD), a Blu-ray (registered trademark) disk or any other optical disk storage, a magnetic cassette, a magnetic tape, a magnetic disk storage or any other magnetic storage device. The program may be transmitted on a transitory computer-readable medium or a communications medium. Without being limited, but examples of the transitory computer-readable medium or the communication medium include an electric signal, an optical signal, an acoustic signal, or any other form of propagation signal.

The present disclosure is not limited to the above example embodiments, and can be appropriately changed without departing from the gist. The present disclosure may be implemented by appropriately combining the example embodiments.

Some or all of the above example embodiments may be described as the following Supplementary Notes, but are not limited to the following.

### (Supplementary Note A1)

An information processing device including:
an identifying means for identifying a shelf on which a commodity that needs to be handled is displayed;
a notification target determination means for determining a target person to be notified of a handling request based on the identified shelf or a commodity displayed on the shelf and information relating to a worker;
a notification method determination means for determining a notification method by which the target person can recognize the shelf or the commodity based on at least one of the identified shelf or the commodity displayed on the shelf, and the determined target person; and
a notification output means for outputting notification information according to the determined notification method to the determined target person.

### (Supplementary Note A2)

The information processing device according to Supplementary Note A1, in which the notification method determination means determines a notification method according to a number of target persons.

### (Supplementary Note A3)

The information processing device according to Supplementary Note A1, in which information relating to the worker is at least one of identification information of the worker associated with the commodity or the shelf, a behavior history of the worker, and position information or behavior information of the worker.

### (Supplementary Note A4)

The information processing device according to Supplementary Note A1, in which the notification target determination means changes the target person according to an elapsed time from a time at which the notification information is output.

### (Supplementary Note B1)

An information processing system including:
an identifying means for identifying a shelf on which a commodity that needs to be handled is displayed;
a notification target determination means for determining a target person to be notified of a handling request based on the identified shelf or a commodity displayed on the shelf and information relating to a worker;
a notification method determination means for determining a notification method by which the target person can recognize the shelf or the commodity based on at least one of the identified shelf or the commodity displayed on the shelf, and the determined target person; and
a notification output means for outputting notification information according to the determined notification method to the determined target person.

### (Supplementary Note B2)

The information processing system according to Supplementary Note B1, in which the notification method determination means determines a notification method according to a number of target persons.

### (Supplementary Note B3)

The information processing system according to Supplementary Note B1, in which information relating to the worker is at least one of identification information of the worker associated with the commodity or the shelf, a behavior history of the worker, and position information or behavior information of the worker.

### (Supplementary Note B4)

The information processing system according to Supplementary Note B1, in which the notification target determination means changes the target person according to an elapsed time from a time at which the notification information is output.

### (Supplementary Note C1)

An information processing method executed by a computer and comprising:
identifying a shelf on which a commodity that needs to be handled is displayed;
determining a target person to be notified of a handling request based on the identified shelf or a commodity displayed on the shelf and information relating to a worker;
determining a notification method by which the target person can recognize the shelf or the commodity based on at least one of the identified shelf or the commodity displayed on the shelf, and the determined target person; and
outputting notification information according to the determined notification method to the determined target person.

### (Supplementary Note C2)

The information processing method according to Supplementary Note C1, further including determining, in the determining of the notification method, a notification method according to a number of the target persons.

### (Supplementary Note C3)

The information processing method according to Supplementary Note C1, in which information relating to the worker is at least one of identification information of the worker associated with the commodity or the shelf, a behavior history of the worker, and position information or behavior information of the worker.

### (Supplementary Note C4)

The information processing method according to Supplementary Note C1, further including changing, in the determining of the target person, the target person according to an elapsed time from a time in a case where the notification information is output.

### (Supplementary Note D1)

A non-transitory computer-readable medium having stored therein a program for causing a computer to execute:
identifying a shelf on which a commodity that needs to be handled is displayed;
determining a target person to be notified of a handling request based on the identified shelf or a commodity displayed on the shelf and information relating to a worker;
determining a notification method by which the target person can recognize the shelf or the commodity based on at least one of the identified shelf or the commodity displayed on the shelf, and the determined target person; and outputting notification information according to the determined notification method to the determined target person.

### (Supplementary Note D2)

The non-transitory computer-readable medium having stored therein a program according to Supplementary Note D1, the computer further executes determining, in the determining of the notification method, a notification method according to a number of the target persons.

### (Supplementary Note D3)

The non-transitory computer-readable medium having stored therein a program according to Supplementary Note D1, in which information relating to the worker is at least one of identification information of the worker associated with the commodity or the shelf, a behavior history of the worker, and position information or behavior information of the worker.

### (Supplementary Note D4)

The non-transitory computer-readable medium having stored therein a program according to Supplementary Note D1, the computer further executes changing, in the determining of the target person, the target person according to an elapsed time from a time in a case where the notification information is output.

### REFERENCE SIGNS LIST

1 information processing device
2 identifying unit
3 notification target determination unit
4 notification method determination unit
5 notification output unit
10 server
11 storage unit
111 program
112 information DB
12 memory
13 communication unit
14 processing unit
141 acquisition unit
142 identifying unit
143 notification target determination unit
144 notification method determination unit
145 notification output unit
20 worker terminal
21 storage unit
22 memory
23 communication unit
24 input/output unit
25 processing unit
251 transmission/reception processing unit
252 notification processing unit
30 camera
40 store
41 display shelf
42 shelf board
100 information processing system
101 information processing system
102 identifying unit
103 notification target determination unit
104 notification method determination unit
105 notification output unit
N network

What is claimed is:

1. An information processing device comprising:
a memory configured to store instructions; and
a processor configured to execute the instructions to:
identify a shelf that needs to be handled regarding display of a commodity;
determine a target person to be notified of a handling request based on the identified shelf or a commodity displayed on the shelf and information relating to a worker;
determine a notification method by which the target person can recognize the shelf or the commodity based on at least one of the identified shelf or the commodity displayed on the shelf, and the determined target person; and
output notification information according to the determined notification method to the determined target person.

2. The information processing device according to claim 1, wherein the processor is configured to execute the instructions to determine a notification method according to a number of target persons.

3. The information processing device according to claim 1, wherein information relating to the worker is at least one of identification information of the worker associated with the commodity or the shelf, a behavior history of the worker, and position information or behavior information of the worker.

4. The information processing device according to claim 1, wherein the processor is configured to execute the instructions to change the target person according to an elapsed time from a time at which the notification information is output.

5-8. (canceled)

9. An information processing method executed by a computer and comprising:
identifying a shelf that needs to be handled regarding display of a commodity;
determining a target person to be notified of a handling request based on the identified shelf or a commodity displayed on the shelf and information relating to a worker;
determining a notification method by which the target person can recognize the shelf or the commodity based on at least one of the identified shelf or the commodity displayed on the shelf, and the determined target person; and
outputting notification information according to the determined notification method to the determined target person.

10. The information processing method according to claim 9, further comprising determining, in the determining of the notification method, a notification method according to a number of the target persons.

11. The information processing method according to claim 9, wherein information relating to the worker is at least one of identification information of the worker associated with the commodity or the shelf, a behavior history of the worker, and position information or behavior information of the worker.

12. The information processing method according to claim 9, further comprising changing, in the determining of the target person, the target person according to an elapsed time from a time in a case where the notification information is output.

13. A non-transitory computer-readable medium having stored therein a program for causing a computer to execute:
identifying a shelf that needs to be handled regarding display of a commodity;
determining a target person to be notified of a handling request based on the identified shelf or a commodity displayed on the shelf and information relating to a worker;
determining a notification method by which the target person can recognize the shelf or the commodity based on at least one of the identified shelf or the commodity displayed on the shelf, and the determined target person; and
outputting notification information according to the determined notification method to the determined target person.

14. The non-transitory computer-readable medium having stored therein a program according to claim 13, the computer further executes determining, in the determining of the notification method, a notification method according to a number of the target persons.

15. The non-transitory computer-readable medium having stored therein a program according to claim 13, wherein information relating to the worker is at least one of identification information of the worker associated with the commodity or the shelf, a behavior history of the worker, and position information or behavior information of the worker.

16. The non-transitory computer-readable medium having stored therein a program according to claim 13, the computer further executes changing, in the determining of the target person, the target person according to an elapsed time from a time in a case where the notification information is output.
